(19) United States
(12) Patent Application Publication
(10) Pub. No.: US 2014/0177230 A1
(43) Pub. Date: Jun. 26, 2014

(54) LIGHTING APPARATUS HAVING NESTED REFLECTORS

(71) Applicant: Stray Light Optical Technologies, (US)

(72) Inventor: Gerald W. Rea, Scottsburg, IN (US)

(21) Appl. No.: 13/841,502

(22) Filed: Mar. 15, 2013

Related U.S. Application Data
(60) Provisional application No. 61/644,786, filed on May 9, 2012.

(51) Int. Cl. F21V 7/00

(52) U.S. Cl. CPC F21V 7/0025
USPC 362/304

(57) ABSTRACT

A lighting apparatus includes a nested reflector. The nested reflector receives a light output from a light source and directs the light output.

### CROSS REFERENCE TO RELATED APPLICATION

This application claims the benefit of U.S. Application Ser. No. 61/644,786, filed on May 9, 2012, which is expressly incorporated herein by reference.

### BACKGROUND AND SUMMARY OF THE DISCLOSURE

The present disclosure relates to reflectors for a lighting apparatus. More particularly, the present disclosure relates to a nested reflector.

In one illustrated embodiment of the present disclosure, a lighting apparatus includes a light source and a nested reflector receiving a light output of the light source and directing the light output. The nested reflector includes an outer reflector and an inner reflector. The outer reflector includes a plurality of separate outer faceted reflective components which are interconnected to form the outer reflector. In an illustrative embodiment, the inner reflector also includes a plurality of separate inner faceted reflective components which are interconnected to form the inner reflector.

In another illustrated embodiment of the present disclosure, a lighting apparatus includes a light source and a nested reflector including a plurality of reflectors. The nested reflector receives a light output from the light source and directs the light output. The nested reflector includes an outer reflector and an inner reflector. The inner reflector is positioned relative to the outer reflector such that a focus of the inner reflector is generally aligned with a focus of the outer reflector. The light source is positioned at the focus of the outer reflector. The lighting apparatus also includes at least two spacers extending between inner reflector and the outer reflector to secure the inner reflector to the outer reflector. Each spacer includes a planar body portion aligned generally perpendicular to the light source to minimize interference with the light output emitted from the light source.

In a further illustrated embodiment of the present disclosure, a light emitting plasma lighting apparatus is driven by a driver which generates a radio frequency (RF) output signal. The light emitting plasma lighting apparatus comprises an emitter including a body portion having an opening therein, and a puck located in the opening of the body portion. The puck has an exposed bottom surface and a plasma bulb coupled to the bottom surface of the puck. The puck is coupled to the driver to receive the RF output signal and provide a concentrated RF field so that light is emitted from an outer surface of the plasma bulb. The light emitting plasma lighting apparatus further includes a nested reflector coupled to the body portion of the emitter to shape light emitted from the plasma bulb into a collimated light pattern focused at infinity. The nested reflector includes an inner reflector and an outer reflector. The inner reflector is positioned relative to the outer reflector such that a focus of the inner reflector is aligned with a focus of the outer reflector. The plasma bulb is positioned at the focus of the outer reflector.

Additional features and advantages of the present disclosure will become apparent to those skilled in the art upon consideration of the following detailed description of illustrative embodiments exemplifying the best mode of carrying out the invention as presently perceived.

### BRIEF DESCRIPTION OF THE DRAWINGS

Features and advantages of this disclosure, and the manner of attaining them, will become more apparent and the invention itself will be better understood by reference to the following description of embodiments of the invention taken in conjunction with the accompanying drawings, wherein:

FIG. 1 is a block diagram illustrating an exemplary light unit apparatus of one embodiment of the present disclosure;

FIG. 2 illustrates a bottom, perspective view of an exemplary reflector of one embodiment of a lighting apparatus;

FIG. 3 illustrates a top, perspective view of the exemplary reflector of FIG. 2;

FIG. 4 illustrates a sectional view taken along lines 4-4 of the exemplary reflector of FIG. 2 along with a representation of a light unit;

FIG. 5 illustrates another exemplary reflector embodiment of a lighting apparatus;

FIGS. 6 and 7 illustrate an exemplary output of the embodiment of FIG. 5;

FIG. 8 illustrates an illumination field of three lighting apparatus having the exemplary reflector of FIG. 5;

FIG. 9 illustrates a location of one of the lighting apparatus of FIG. 8;

FIG. 10 illustrates another exemplary reflector embodiment of a lighting apparatus;

FIG. 11 illustrates a sectional view along lines 11-11 of the exemplary reflector of FIG. 10;

FIG. 12 illustrates an illumination field of two lighting apparatus having the exemplary reflector of FIG. 10;

FIG. 13 illustrates a location of one of the lighting apparatus of FIG. 12; and

FIG. 14 is a diagrammatical illustration of the nested reflector of one embodiment of the present disclosure.

Corresponding reference characters indicate corresponding parts throughout the several views. The drawings set out herein illustrate exemplary embodiments of the invention and such drawings are not to be construed as limiting the scope of the invention in any manner.

### DETAILED DESCRIPTION OF THE DRAWINGS

For the purposes of promoting an understanding of the principles of the present disclosure, reference will now be made to the embodiments illustrated in the drawings, which are described below. The embodiments disclosed below are not intended to be exhaustive or limit the present lighting system to the precise form disclosed in the following detailed description. Rather, the embodiments are chosen and described so that others skilled in the art may utilize their teachings. Therefore, no limitation of the scope of the lighting system is intended. The present lighting system includes any alterations and further modifications of the illustrated devices, systems and described methods and further applications of the principles of the present disclosure which would normally occur to one skilled in the art.

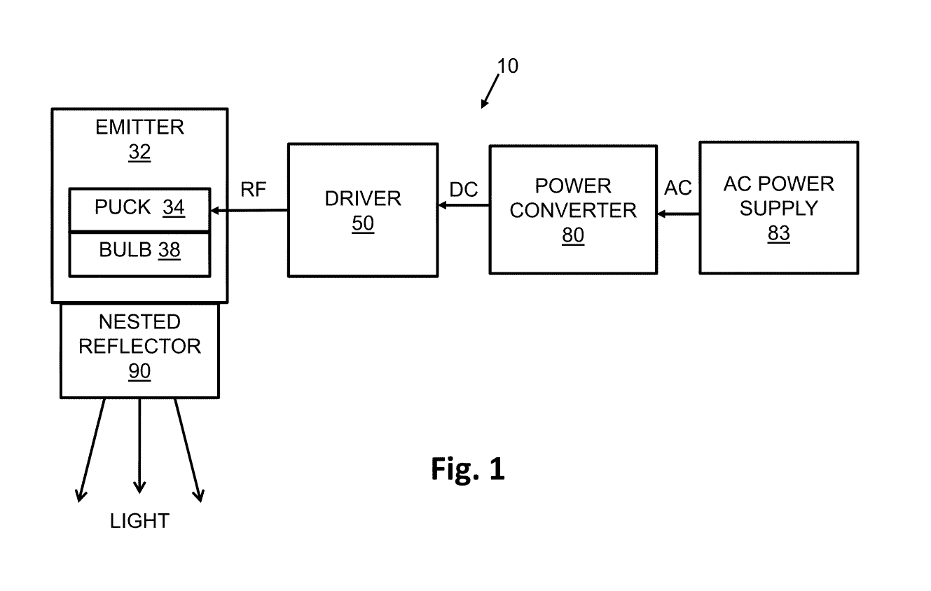

Referring now to the drawings, FIG. 1 illustrates an exemplary lighting apparatus 10. The lighting apparatus 10 illustratively includes an emitter 32 which receives a radio frequency (RF) signal from a power amplifier or driver 50. The emitter 32 includes a body portion having an opening therein. A resonant cavity or puck 34 is located in the opening of the body portion of emitter 32. The puck 34 has an exposed bottom surface and a plasma bulb 38 coupled to the bottom surface of the puck 34. The RF signal is input into puck 34 which creates a standing wave confined within its walls. The electric field of the standing wave is strongest at the center of the bulb 38 resulting in the ionization of the gasses inside the bulb 38. The ionized gas vaporizes contents of the bulb 38 into a plasma state at the center of bulb 38 to generate an intense source of light. An exemplary emitter is model number STA 41-02 light emitting plasma emitter available from Luxim® located in Sunnyvale, Calif. Additional details regarding various components of lighting apparatus 10 are described in PCT Published Application No. WO/2012/031287, titled LIGHTING APPARATUS, filed Sep. 3, 2011, the disclosure of which is expressly incorporated by reference herein.

Driver 50 receives DC power from a power source or power converter 80. Power converter 80 receives AC power from an AC power supply 83, such as the grid, and rectifies the AC power to produce a DC power signal output from power converter 80.

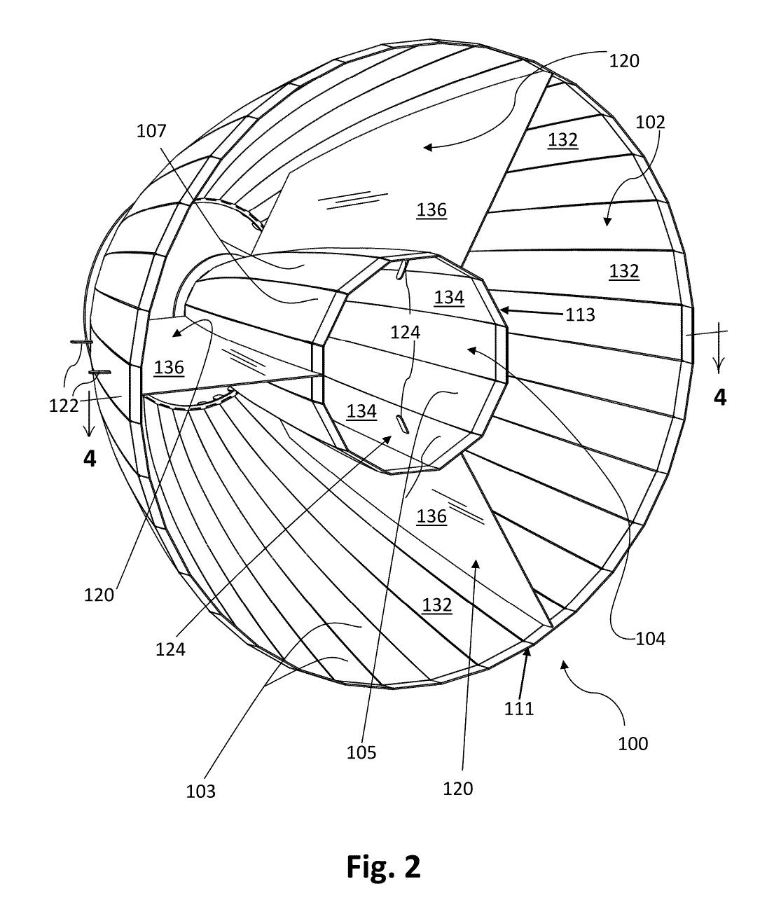

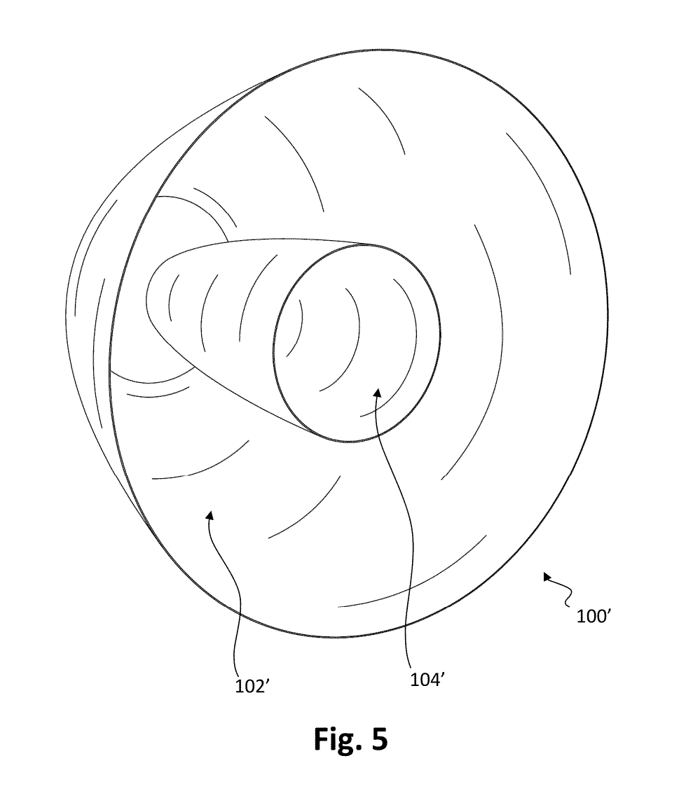

As shown in FIG. 1, the light emitted by bulb 38 is directed by a nested reflector 90. Reflector 90 alters the direction of the light exiting bulb 38 to shape a desired illumination pattern on a spaced apart object. Exemplary spaced apart objects include the ground, floors, desktops, and other surfaces to be illuminated. In one embodiment, the illumination pattern on the spaced apart surface is shaped in multiple directions. An exemplary reflector 100 for shaping the illumination pattern in multiple directions is shown in FIGS. 2-4. Another exemplary reflector 100′ for shaping the illumination pattern in multiple directions is shown in FIG. 5. Although a plasma light source is shown in FIG. 1, other exemplary light sources and associated power devices may be used including light emitting diodes (LEDs) and other suitable light sources.

Referring to FIGS. 2-4, an exemplary nested reflector 100 is shown. Reflector 100 includes a first, outer reflector 102 and a second, inner reflector 104 nested in first reflector 102. In the illustrated embodiment, two reflectors are shown. In another illustrated embodiment, more than two reflectors are used.

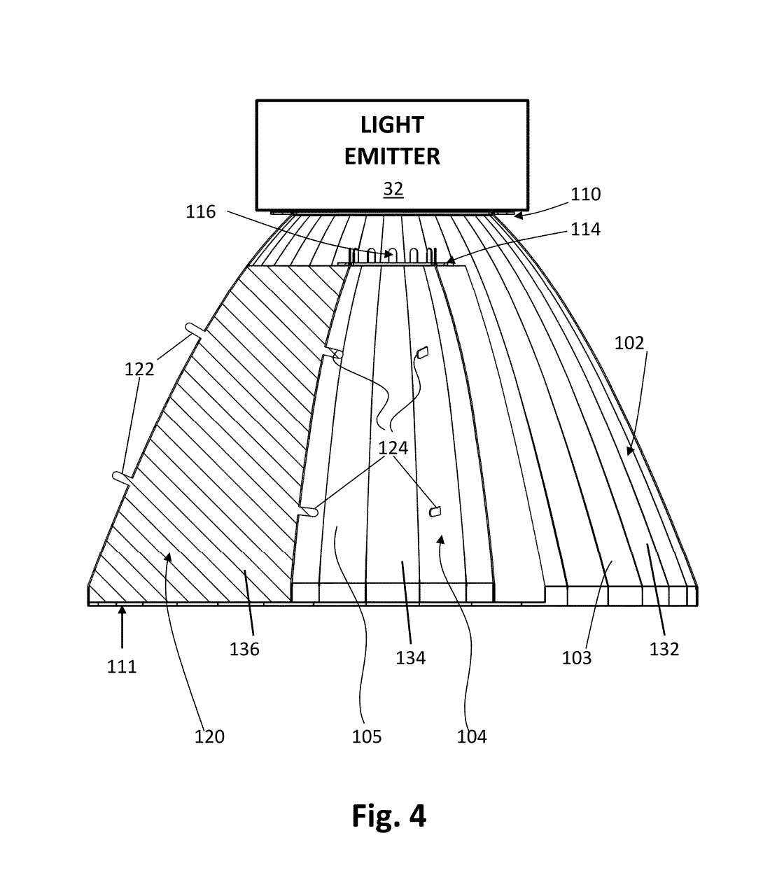

The inner surfaces 103 and 105 of respective reflectors 102 and 104 reflect the light from the emitter 32 to shape the light output by bulb 38 (see FIG. 4). Further, the outer surfaces 107 of reflector 104 also reflects the light from emitter 32. Along the length of reflector 100, each of reflectors 102 and 104, have at least one of a hyperbolic shape, a parabolic shape, an elliptical shape, a spherical shape, and an oblate elliptical shape. In one illustrated embodiment, reflectors 102 and 104 have the same shape with different curvatures. In another illustrated embodiment, reflectors 102 and 104 have different shapes and different curvatures. In yet another illustrated embodiment, one or both of reflectors 102 and 104 include multiple shapes. In a further embodiment, one or both of reflectors 102 and 104 include at least one non-conical shape.

Each of reflector 102 and reflector 104 includes multiple faceted sections 132 and 134, respectively, which form faceted reflectors that approximate generally spherical reflectors. Exemplary spherical, non-faceted reflectors 102′ and 104′ are shown in FIG. 5.

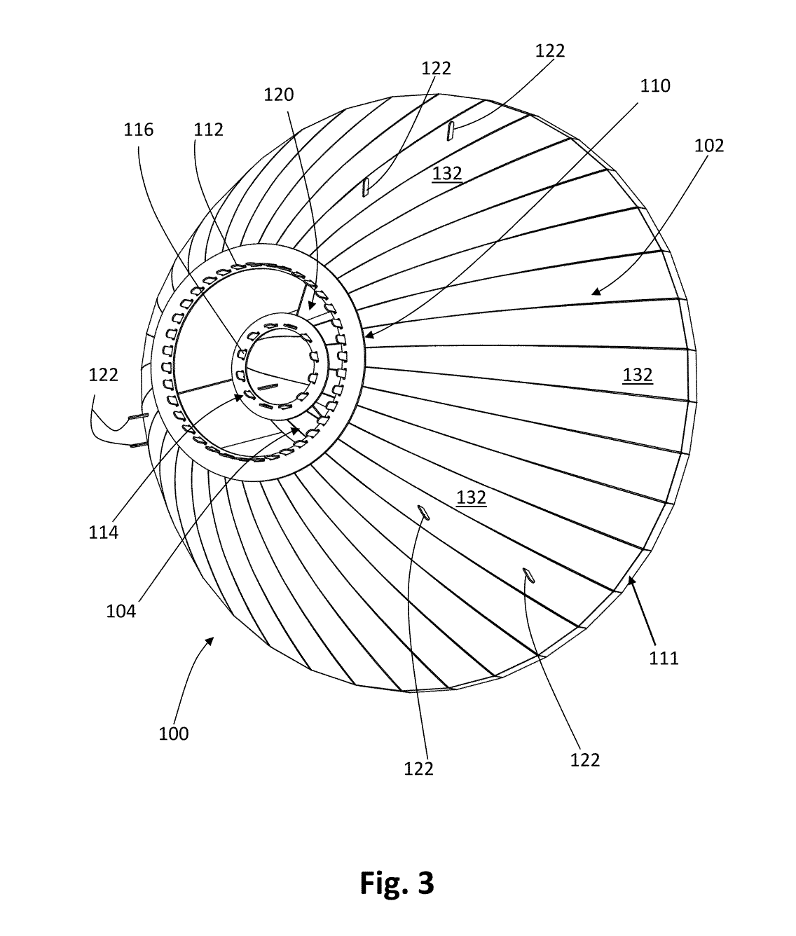

Referring to FIG. 3, first ends of the faceted sections 132 of reflector 102 are held together by a coupler 110. Coupler 110 includes a plurality of apertures configured to receive tabs 112 extending from each of the faceted sections 132 of reflector 102. The tabs 112 are shown unbent, but are bent over to contact the upper surface of coupler 110 to secure the faceted sections 132 of reflector 102 to coupler 110. The tabs 112 may be secured to coupler 110 by an adhesive, welding or other bonding method. In a like manner, a first end of the faceted sections 134 of reflector 104 are held together through a coupler 114. Coupler 114 includes a plurality of apertures configured to receive tabs 116 extending from the faceted sections 134 of reflector 104. The tabs 116 are shown unbent, but are bent over to contact the upper surface of coupler 114. The tabs 116 may be secured to coupler 110 by an adhesive, welding or other bonding method.

In one embodiment, second ends 111 of faceted sections 132 of reflector 102 are held together by a ring shaped coupler or tabs. In another embodiment, second ends 111 of faceted sections 132 are integrally formed. Likewise, in one embodiment, second ends 113 of faceted sections 134 of inner reflector 104 are held together by a ring shaped coupler or tabs. In another embodiment, second ends 113 of faceted sections 134 are integrally formed.

The position of reflector 104 relative to reflector 102 is maintained in the illustrated embodiment through spacers 120. In the illustrated embodiment, three spacers 120 are shown. In other embodiments, fewer or more spacers 120 may be used. Spacers 120 include tabs 122 which extend through corresponding openings in reflector 102 and tabs 124 which extend through corresponding openings in reflector 104. Tabs 122 and 124 are shown unbent. In one embodiment, tabs 122 and 124 are bent over to secure the spacers 120 to reflectors 102 and 104, respectively. The spacers 120 include planar body portions 136 which are aligned generally perpendicular to the light bulb 38 to minimize the blocking or occluding effect of spacers 120 on the light emitted by bulb 38.

Referring now to FIG. 5, another exemplary embodiment of the nested reflector 100′ is shown. The reflectors 102′ and 104′ of reflector 100′ are held in position by spacers 120 (not shown) similar to the spacers 120 of FIGS. 2-4. As discussed above, reflectors 102′ and 104′ are one-piece reflectors without faceted sections 132 and 134.

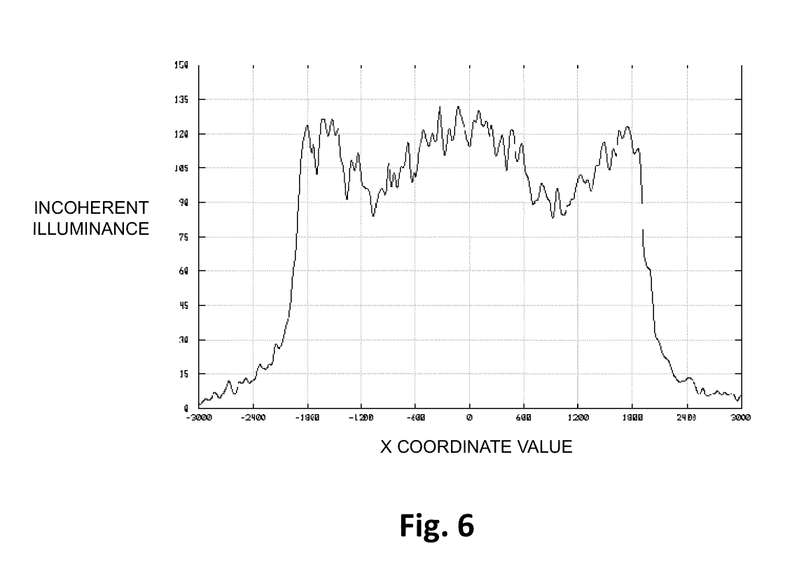

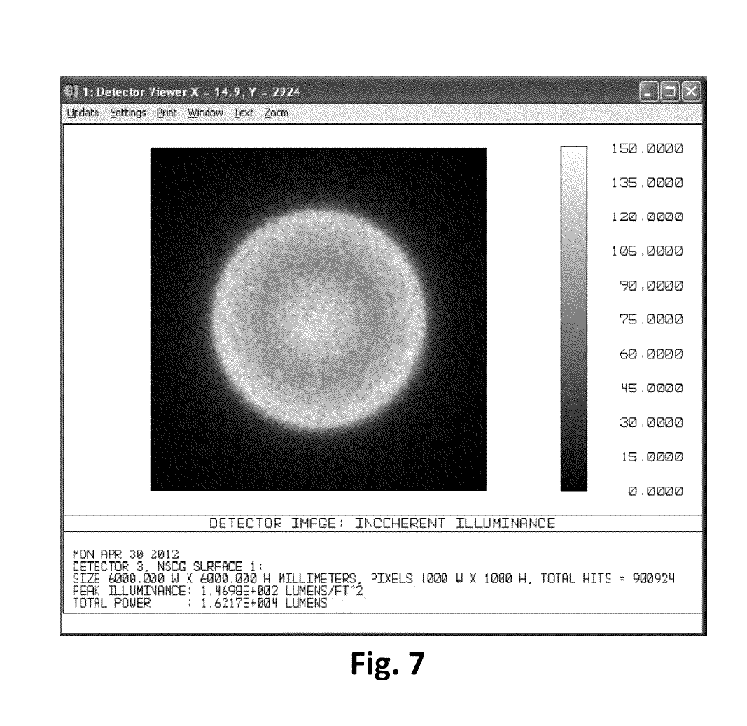

Referring to FIGS. 6 and 7, an exemplary output of nested reflector 100′ is shown wherein a light source such as bulb 38 is positioned at the focus of both reflector 102′ and reflector 104′ whose foci are generally aligned.

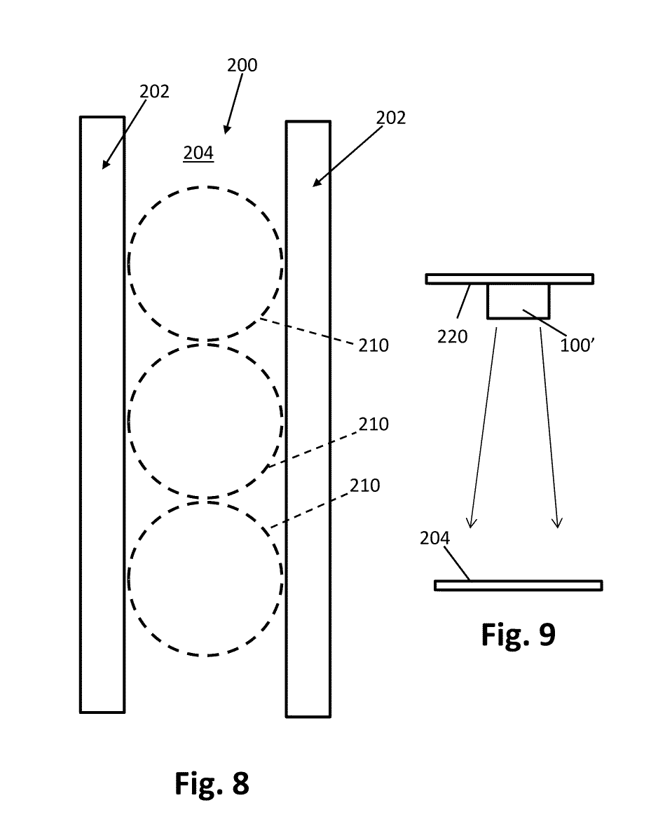

Referring to FIG. 9, nested reflector 100′ is shown supported from a support structure 220. Exemplary support structures 220 include a ceiling, wall or other support. Light is directed by nested reflector 100′ towards a floor 204 or other surface to be illuminated. Referring to FIG. 8, an illumination pattern 210 of three nested reflectors 100′ is illustrated for an aisleway 200 wherein the floor 204 is bound on opposite sides by objects 202. Exemplary objects 202 include walls, display stands, shelves, seats, and other objects. The illumination patterns 210 from the three reflectors 100′ illustratively does not fill the floor space 204 of the aisleway.

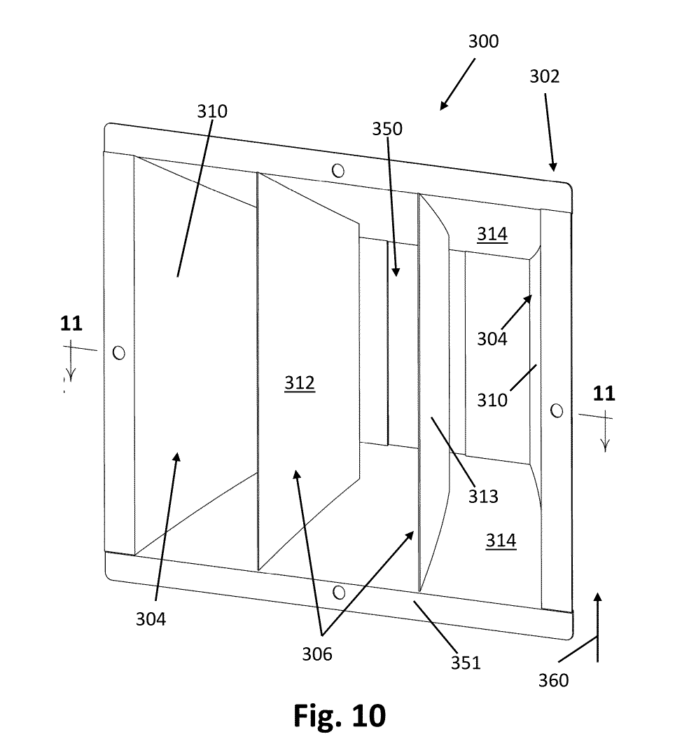

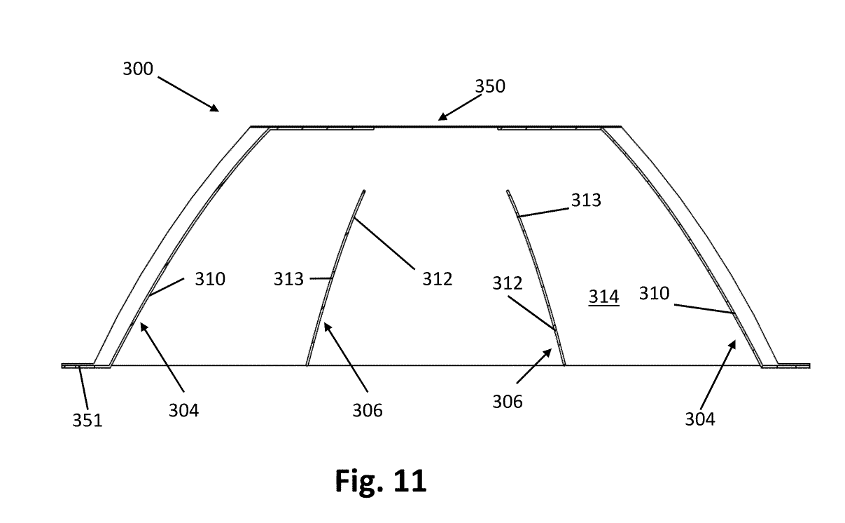

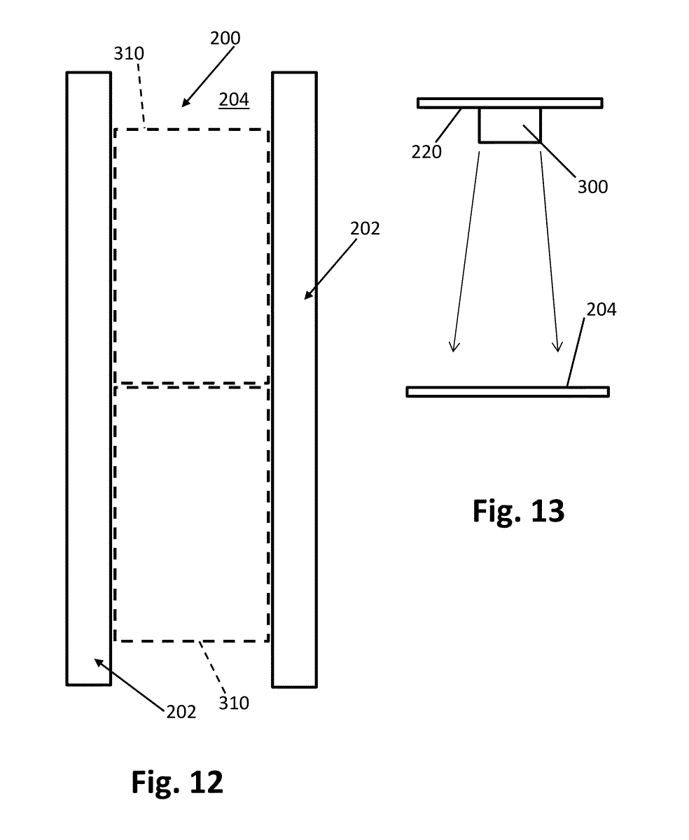

In another embodiment, the illumination pattern on the spaced apart surface is shaped generally in a first direction. An exemplary reflector 300 for shaping in generally a first direction is shown in FIGS. 10 and 11. Referring to FIGS. 12 and 13, the illumination pattern 310 of reflector 300 fills more of the floor space 204 than reflector 100′.

Referring to FIG. 10 reflector 300 includes a frame 302 having a first reflector 304 and a second reflector 306 nested in first reflector 304. Light from an elongated light source, such as multiple LEDs or plasma sources, enters through an opening 350 in the top of reflector 300. The light is reflected off of surfaces 310 of first, outer reflector 304 and surfaces 312 and 313 of second, inner reflector 306.

Each of reflectors 304 and 306 include multiple spaced apart components. In one embodiment, surfaces 314 of frame 302 are also reflective surface of reflector 304.

In the illustrated embodiment, surfaces 310 and 312 are generally linear in direction 360 and have at least one of a hyperbolic shape, a parabolic shape, an elliptical shape, a spherical shape, and an oblate elliptical shape in a direction 360 extending from the bottom 351 of reflector 300 towards opening 350. In one embodiment, surfaces 310 and 312 have the same shape with different curvatures. In another embodiment, surfaces 310 and 312 have different shapes and different curvatures. In yet another embodiment, one or both of surfaces 310 and 312 include multiple shapes. In a further embodiment, one or both of surfaces 310 and 312 include at least one non-conical shape.

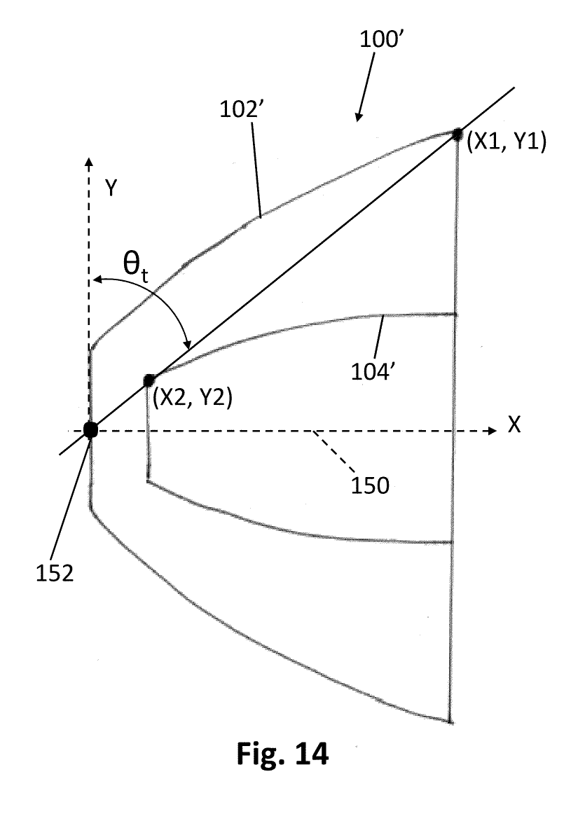

FIG. 14 is a diagrammatical view of one embodiment of nested reflectors 100′. The reflector 100′ of FIG. 14 provides the same collimating power as single reflector having about 6 times the size, thereby saving space and material. Reflector 100′ functions by nesting a second spherical reflector 104′ inside the first reflector 102′. Both reflectors 102′ and 104′ center on the same optical axis 150 with same focal point 152 (the source). The maximum angle of light escaping the reflector is the same as the larger reflector. This design works well with high intensity lighting sources which are small and emit light only in the forward direction. These sources include light emitting diodes (LEDs) and light emitting plasma bulbs 38.

Mathematical representation of the nested reflector is as follows (equation 1):

$$z = \frac{{cr}^{2}}{1 + \sqrt{1 - ( 1 + k ) {c}^{2} {r}^{2}}}$$

z=sag coordinate
c=curvature (reciprocal of the radius)
r=radial coordinate (in lens units)
k=conic constant (less than −1 for hyperbolas, −1 for parabolas, between −1 and 0 for ellipses, 0 for spheres, and greater than 0 for oblate ellipsoids)

The focal point is the source and is held constant. Otis the transition angle, where the incident light transitions from the outer reflector 102′ to the inner (nested) reflector 104′.

If the nested reflector was infinitely thin,

$$\frac{x 1}{y 1} = \frac{x 2}{y 2}$$

and no light would be lost. However, some occlusion must occur because the nested reflector must have a thickness. The reflected angle of light (with respect to the optical axis) at x1, y1 is equal to the reflected angle of light at x2, y2. This creates a continuous geometric transition for the light from a discrete geometry. The two reflectors are created by solving for the curvature that follows the line (x1,y1) to (x2,y2). The nested reflector may be used in many embodiments including axiconic, hyperbolic, parabolic, linear, ellipsoids, or combinations of the different types.

In the illustrated embodiment, there is a slight occlusion caused by the back portion of the nested portion 104′ of the reflector 100′ (since the inner reflector 104′ has a thickness). In order to correct for this occlusion, in one illustrated embodiment the inner reflector 104′ is made slightly hyperbolic (k of −1.02) and the outer reflector 102′ may be made slightly ellipsoidal (k of −0.98). In another illustrated embodiment, the nested reflector 104′ is only in one plane and extended linearly in order to create collimation (beam shaping) in only direction creating a linear pattern. Both inner and outer reflectors 104′ and 102′ provide a collimated light pattern focused at infinity. The nested reflector 100′ is used in reverse as a collector to gather light in another illustrated embodiment.

FIG. 6 illustrates an Optical Pattern of the nested reflector output at 30,000 lens units. Illumination levels are high over the entire pattern offering a very good design for tight and medium beam reflectors. In one embodiment, to fully solve the equation 1, since the curvatures are different, the inner reflector is be shifted along the z (or optical) axis until the reflected angle at x2, y2 is achieved. In the example of FIG. 14, this shift is 18 lens units.

While this disclosure has been described as having exemplary designs and embodiments, the present system may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. A lighting apparatus, comprising:
a light source;
a nested reflector receiving a light output of the light source and directing the light output, the nested reflector including an outer reflector and an inner reflector, the outer reflector including a plurality of separate outer faceted reflective components which are interconnected to form the outer reflector.

2. The apparatus of claim 1, wherein the inner reflector also includes a plurality of separate inner faceted reflective components which are interconnected to form the inner reflector.

3. The apparatus of claim 2, wherein each of the outer and inner faceted reflective components includes a first end having a tab and a second end, the tabs on the first ends of the outer faceted reflective components extending through a plurality of openings formed in an outer coupler to secure the plurality of outer faceted reflective components together, and the tabs on the first ends of the inner faceted reflective components extending through a plurality of openings formed in an inner coupler to secure the plurality of outer faceted reflective components together.

4. The apparatus of claim 3, further comprising an outer connecting ring coupled to the second ends of the outer faceted reflective components and an inner connecting ring coupled to the second ends of the inner faceted reflective components.

5. The apparatus of claim 1, wherein the inner reflector is coupled to the outer reflector by at least two spacers extending between inner reflector and the outer reflector, each spacer including a planar body portion aligned generally perpendicular to the light source to minimize interference with light output emitted from the light source.

6. The apparatus of claim 5, wherein the inner reflector is coupled to the outer reflector by at least three spacers.

7. The apparatus of claim 5, wherein each spacer includes an inner side edge and an outer side edge located adjacent the inner reflector and outer reflector, respectively, and mounting tabs extending from the inner and outer side edges configured to enter slots formed in the inner reflector and outer reflector, respectively, to secure the spacers to the inner and outer reflectors.

8. The apparatus of claim 1, wherein the inner and outer reflectors have different shapes.

9. The apparatus of claim 8, wherein the inner reflector is a hyperbolic paraboloid and the outer reflector is an elliptical paraboloid.

10. The apparatus of claim 1, wherein the inner and outer reflectors are each configured to provide collimated light beams focused at infinity.

11. A lighting apparatus, comprising:
a light source;
a nested reflector including a plurality of reflectors, the nested reflector receiving a light output from the light source and directing the light output, wherein the nested reflector includes an outer reflector and an inner reflector, the inner reflector being positioned relative to the outer reflector such that a focus of the inner reflector is generally aligned with a focus of the outer reflector, the light source being positioned at the focus of the outer reflector; and
at least two spacers extending between inner reflector and the outer reflector to secure the inner reflector to the outer reflector, each spacer including a planar body portion aligned generally perpendicular to the light source to minimize interference with the light output emitted from the light source.

12. The apparatus of claim 11, wherein the inner reflector is coupled to the outer reflector by at least three spacers.

13. The apparatus of claim 11, wherein each spacer includes an inner side edge and an outer side edge located adjacent the inner reflector and outer reflector, respectively, and mounting tabs extending from the inner and outer side edges configured to enter slots formed in the inner reflector and outer reflector, respectively, to secure the spacers to the inner and outer reflectors.

14. The apparatus of claim 11, wherein the inner and outer reflectors have different shapes.

15. The apparatus of claim 14, wherein the inner reflector is a hyperbolic paraboloid and the outer reflector is an elliptical paraboloid.

16. The apparatus of claim 11, wherein the inner and outer reflectors are each configured to provide collimated light beams focused at infinity.

17. A light emitting plasma lighting apparatus driven by a driver which generates a radio frequency (RF) output signal, the apparatus comprising:
an emitter including a body portion having an opening therein, and a puck located in the opening of the body portion, the puck having an exposed bottom surface and a plasma bulb coupled to the bottom surface of the puck, the puck being coupled to the driver to receive the RF output signal and provide a concentrated RF field so that light is emitted from an outer surface of the plasma bulb; and
a nested reflector coupled to the body portion of the emitter to shape light emitted from the plasma bulb into a collimated light pattern focused at infinity, the nested reflector including an inner reflector and an outer reflector, the inner reflector being positioned relative to the outer reflector such that a focus of the inner reflector is aligned with a focus of the outer reflector, and wherein the plasma bulb is positioned at the focus of the outer reflector.

18. The apparatus of claim 17, wherein the inner reflector is coupled to the outer reflector by at least two spacers extending between inner reflector and the outer reflector, each spacer including a planar body portion aligned generally perpendicular to the light source to minimize interference with light output emitted from the light source.

19. The apparatus of claim 17, wherein the outer reflector includes a plurality of separate outer faceted reflective components which are interconnected to form the outer reflector, and the inner reflector also includes a plurality of separate inner faceted reflective components which are interconnected to form the inner reflector.

20. The apparatus of claim 17, wherein the inner and outer reflectors have different shapes.
